(19) United States
(12) Patent Application Publication
(10) Pub. No.: US 2011/0317409 A1
(43) Pub. Date: Dec. 29, 2011

(54) Structure of lighting device

(75) Inventors: Chih-Hsien Wu, San Chung City (TW); Chung-Yu Wang, San Chung City (TW); Meng-Chieh Chou, San Chung City (TW)

(73) Assignee: Unity Opto Technology Co., Ltd., San Chung City (TW)

(21) Appl. No.: 12/801,729

(22) Filed: Jun. 23, 2010

(51) Int. Cl. F21V 29/00

(52) U.S. Cl. 362/218

(57) ABSTRACT

A structure of lighting device includes a heat dissipater having opposite edges respectively forming a guide slot and a groove. A substrate board has an edge received and retained in the guide slot and an opposite edge forming a mounting hole. A fastener is received through the mounting hole to tightly engage the groove so as to fix the substrate board to the heat dissipater. No pre-machining of thread tapping is needed to form inner-threaded holes first. The structure of lighting device offers advantages in respect of simple structural arrangement, efficient manufacturing and production, reduced labor and material used, and lowering of costs.

### FIELD OF THE INVENTION

The present invention relates to a structure of lighting device, and in particular to a structure of lighting device applicable to light-emitting diode (LED).

### BACKGROUND OF THE INVENTION

A lighting device is commonly used to improve a space of dim light or a location where light is shielded for ensuring sufficiency of lighting and protecting eyes against poor eyesight or eye diseases, such as myopia, caused by long term insufficiency of lighting. Further, the trend of energy saving and carbon reduction and the invention of light-emitting diodes (LEDs) cause the traditional light sources of tungsten filament bulbs, which consume a large amount of power, to be gradually replaced by LEDs, which are of a small size and consume a minor amount of power.

A conventional lighting device is often composed of a circuit board, a base, and a hood. The circuit board carries a plurality of LEDs mounted thereon and is fixed on the base. The base and the hood are coupled to each other. The circuit board comprises a circuit that controls the operation of the light-emitting elements to give off light. However, the base must be pre-machined through tapping operation to form inner-threaded holes therein. The circuit board is then fixed to the base by being secured by screws that are tightened to the inner-threaded holes one by one. This operation is troublesome. Further, the screws are tightened in a one-by-one manner and a large number of screws are used in securely fixing the circuit board. This often leads to unbalance distribution of tightening force and warp and deformation of the circuit board.

Thus, the present invention aims to provide a structure of lighting device that allows for efficiently quick assembling to improve the convenience of use of the lighting device.

### SUMMARY OF THE INVENTION

An objective of the present invention is to provide a structure of lighting device that allows for efficiently quick assembling of the lighting device.

Another objective of the present invention is to provide a structure of lighting device, which effectively eliminate warp of substrate boards caused by tightening of screws.

A further objective of the present invention is to provide a structure of lighting device that is advantageous in reducing labor and material used and lowering costs.

To realize the above objectives, the present invention provides a structure of lighting device, which comprises a heat dissipater having an edge forming a guide slot and an opposite edge forming a groove; at least one substrate board having a surface carrying at least one light-emitting diode electrically connected therewith, an edge receivable and thus retainable in the guide slot, and an opposite edge forming at least one mounting hole corresponding the groove; and at least one fastener received through the mounting hole to tightly engage the groove so as to securely fix the substrate board to the heat dissipater. As such, the substrate board can be efficiently assembled to the heat dissipater and shows advantages in respect of simple structural arrangement, efficient manufacturing and production, reduced labor and material used, and lowered costs. Further, warp of the substrate board caused by tightening screws that was commonly encountered in the conventional devices can be effectively eliminated to thereby improve the convenience of use of the lighting device.

### BRIEF DESCRIPTION OF THE DRAWINGS

The present invention will be apparent to those skilled in the art by reading the following description of a preferred embodiment thereof with reference to the drawings, in which:

FIGS. 1A and 1B are perspective views of a lighting device constructed in accordance with the present invention;

FIG. 2 is a cross-sectional view taken along line A-A′ of FIG. 1A;

FIG. 3 is an exploded view of the lighting device of the present invention;

FIG. 4 is a perspective view of a portion of the lighting device of the present invention in an enlarged form; and

FIG. 5 is an exploded view of the portion of the lighting device of the present invention.

### DETAILED DESCRIPTION OF THE PREFERRED EMBODIMENT

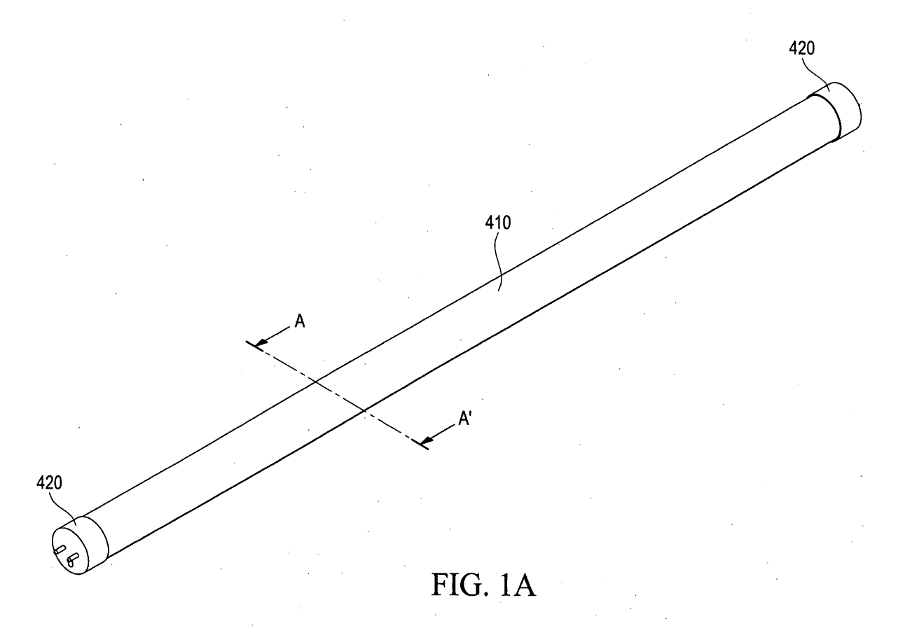

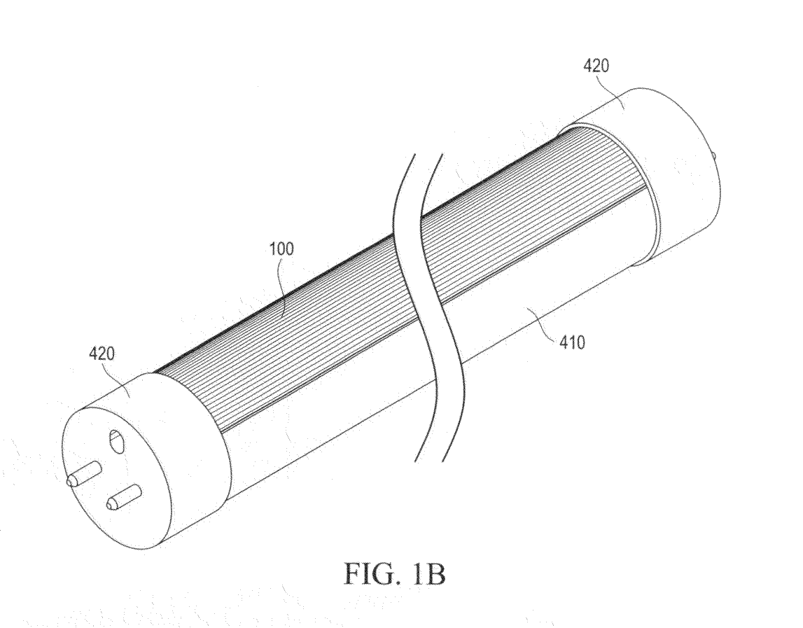

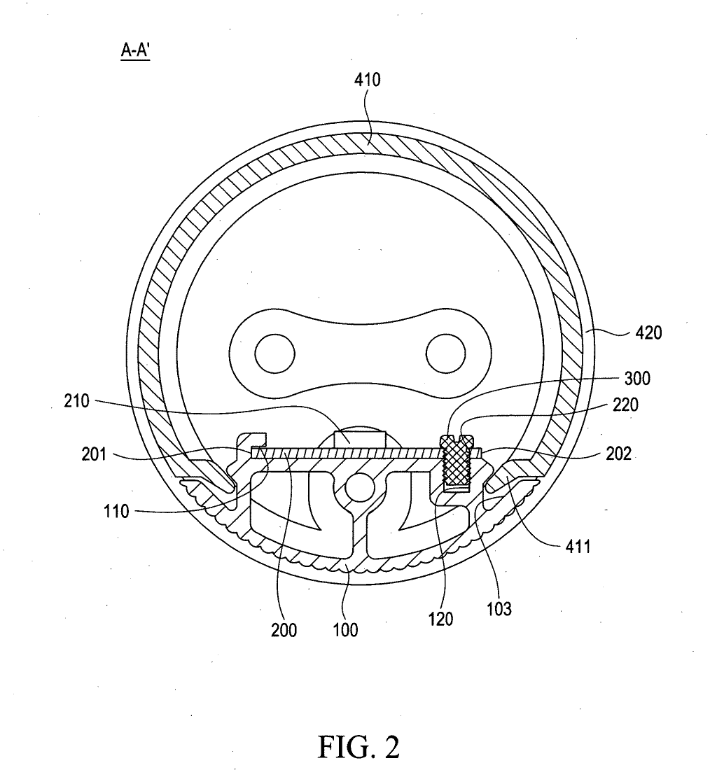

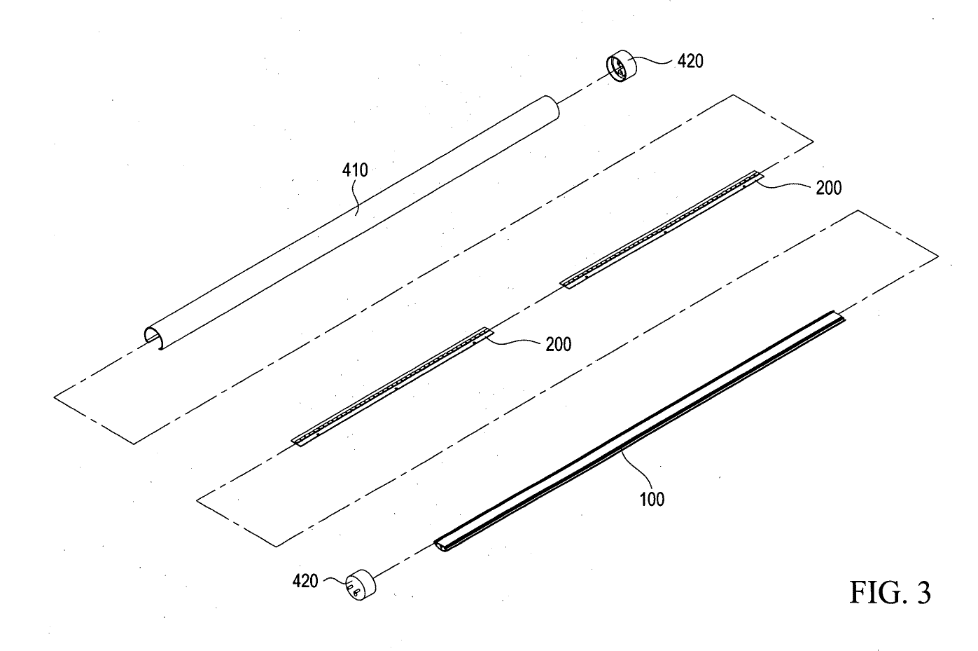

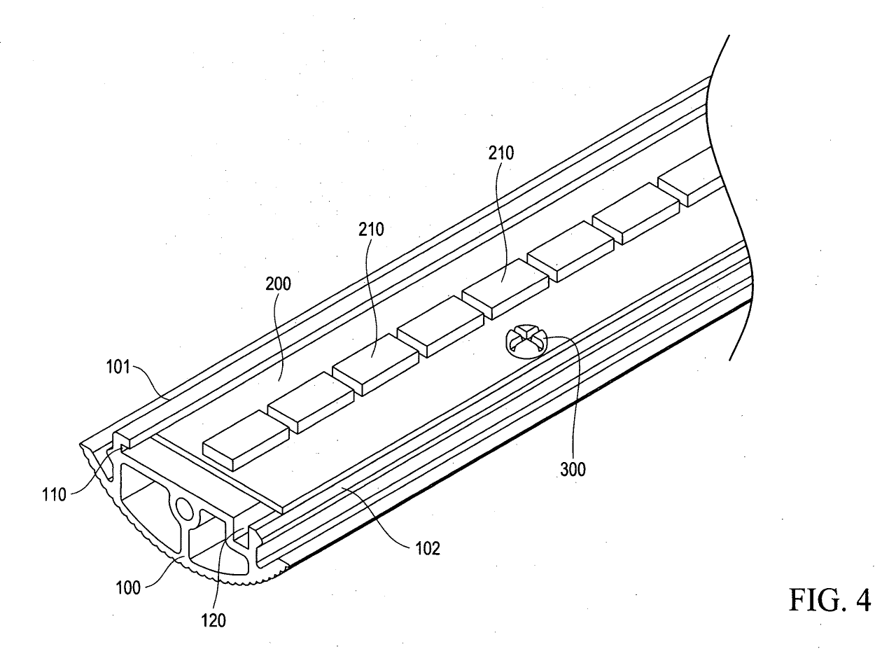

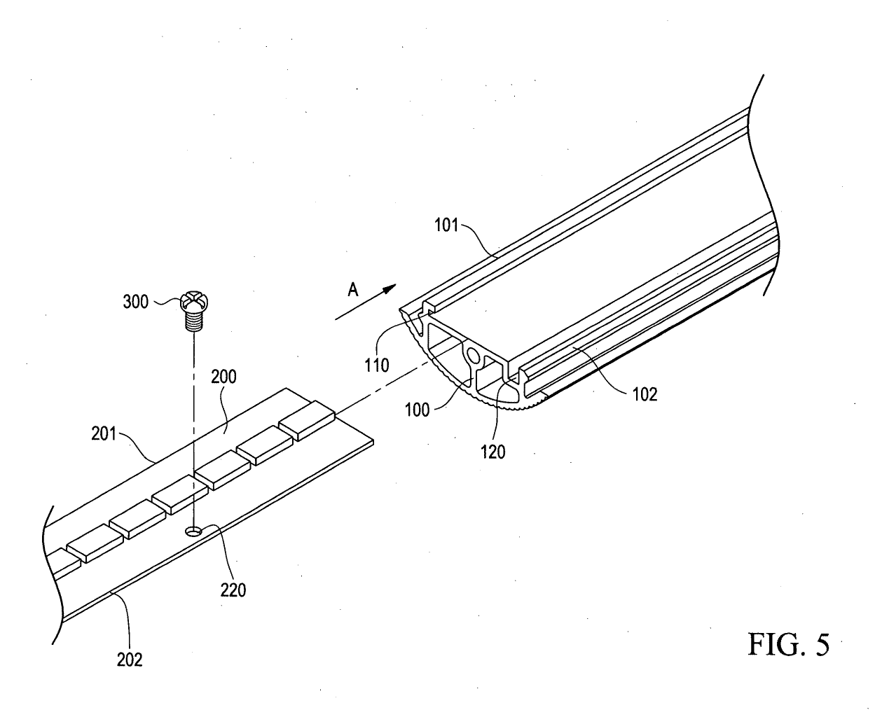

An embodiment of the present invention will be described in detail with reference to the drawings and in particularly to FIGS. 1A-5, which are respectively a perspective view of a lighting device constructed in accordance with the present invention, a cross-sectional view taken along line A-A′ of FIG. 1A, an exploded view of the lighting device of the present invention, a perspective view of a portion of the lighting device of the present invention in an enlarged form, and an exploded view of the portion of the lighting device of the present invention. The lighting device of the present invention comprises a heat dissipater 100, at least one substrate board 200, and at least one fastener 300, for the purpose of realizing an efficiently quick assembling operation in mounting the substrate board 200 and preventing the substrate board 200 for warp and deformation.

The heat dissipater 100 is preferably a heat dissipation member made of aluminum extrusion. The heat dissipater 100 has a first edge 101 in which a guide slot 110 is defined and a second edge 102 in which a groove 120 is defined. (In other words, the guide slot 110 and the groove 120 are respectively formed in two opposite edges 101, 102 of the heat dissipater 100.)

The substrate board 200 has a first edge 201 that is received and retained in the guide slot 110. The substrate board 200 has a surface (which preferably forms a circuit) carrying at least one light-emitting diode (LED) 210 mounted thereto and electrically connected therewith. The substrate board 200 has a second edge 202 in which at least one the mounting hole 220 is formed to correspond to the groove 120.

The fastener 300 (which in the embodiment illustrated comprises a screw or bolt) has an outside diameter that is greater than width of the groove 120 of the heat dissipater 100, whereby the fastener 300 is received through the mounting hole 220 to fit into and tightly engage the groove 120 for securing the substrate board 200 to the heat dissipater 100. Thus, the heat dissipater 100 may conduct heat generated during the operation of the substrate board 200 to the surrounding for dissipation.

Further, the lighting device according to the present invention further comprises a hood 410 and two caps 420. The heat dissipater 100 and the hood 410 mate and are thus coupled to each other. For example, the hood 410 forms pawls 411, while the heat dissipater 100 forms retention slots 103 corresponding to the pawls 411. With the pawls 411 and the retention slots 103 engaging each other, the heat dissipater 100 and the hood 410 are coupled to each other. The substrate board 200 can then be received and retained between the heat dissipater 100 and the hood 410. The two caps 420 are then respectively mounted to opposite ends of the combined structure of the heat dissipater 100 and the hood 410.

In the embodiment illustrated, the fastener 300 comprises a screw (or a bolt) and the substrate board 200 comprises a circuit board on which a plurality of light-emitting diodes 210 is mounted. To mount the substrate board 200, the first edge 201 of the substrate board 200 is first inserted in the direction indicated by A into the guide slot 110 of the heat dissipater 100 so as to secure the first edge 201 of the substrate board 200 in the guide slot 110. The second edge 202 of the substrate board 200 forms at least one mounting hole 220 corresponding to the groove of the heat dissipater 100 and thus the fastener 300 is received through the mounting hole 220 to fit into and tightly engage the groove 120, whereby the substrate board 200 can be directly fixed to the heat dissipater 100. This structural arrangement is simple and no pre-tapped threaded hole is needed. The fastener 300 can be directly fit into and engage the groove 120, making it possible to realize efficient production, reduction of labor and material used, and lowering costs.

Further, the substrate board 200 is directly and efficiently mounted to the heat dissipater 100 through first fitting and retaining the first edge 201 of the substrate board 200 in the guide slot 110, and thus applying the fastener 300 that is received through the mounting hole 220 defined in the second edge 202 of the substrate board 200 to screw into the groove 120 of the heat dissipater 100, whereby warp of the substrate board 200 having a great length caused by fastening a number of screws to secure the long substrate board 200 can be eliminated and further, the distance between adjacent fasteners 300 can be shortened to ensure better compliancy of the substrate board to the heat dissipater.

In summary, the lighting device according to the present invention is generally composed of a heat dissipater 100, at least one substrate board 200, and at least one fastener 300. The heat dissipater 100 has opposite edges 101, 102, which respectively form a guide slot 110 and a groove 120. Each substrate board 200 has a first edge 201 receivable and thus retained in the guide slot 110 and a second edge 202 forming at least one mounting hole 220 corresponding to the groove 120, whereby with the fastener 300 put through the mounting hole 220 to directly screw into the groove 120, the substrate board 200 can be efficiently mounted and fixed to the heat dissipater 100. Advantages including simple structural arrangement, efficient manufacturing and production, reduction of labor and material used, and lowering of manufacturing costs is realized. In addition, no pre-machining of thread tapping for formation of threaded hole is needed; therefore, warp of the substrate board 200 that occurs in the conventional device as being fixed by screws can be eliminated, and better compliancy of the substrate to the heat dissipater is ensured. Thus, an efficacy of convenience of use is provided.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A lighting device, comprising:
a heat dissipater, which has a first edge forming a guide slot and a second edge forming a groove;
at least one substrate board, which has a surface carrying at least one light-emitting diode electrically connected therewith, the substrate board having a first edge received and retained in the guide slot and a second edge forming at least one mounting hole corresponding to the groove; and
at least one fastener, which is received through the mounting hole and tightly engage the groove to securely fix the substrate board to the heat dissipater.

2. The lighting device as claimed in claim 1, wherein the heat dissipater comprises an aluminum-extruded heat dissipation member.

3. The lighting device as claimed in claim 1, wherein the fastener has a diameter that is greater than width of the groove.

4. The lighting device as claimed in claim 1, wherein the fastener comprises a screw.

5. The lighting device as claimed in claim 1 further comprising a hood and two caps, wherein the heat dissipater and the hood are coupled to each other to receive the substrate board between the heat dissipater and the hood, the two caps being respectively coupled to opposite ends of a combination of the heat dissipater and the hood.
